(19) United States
(12) Patent Application Publication
(10) Pub. No.: US 2008/0003091 A1
(43) Pub. Date: Jan. 3, 2008

(54) METHOD AND APPARATUS FOR TRANSPORTING, QUEUING, AND LOADING OF LARGE AREA SUBSTRATES IN MULTI-TOOL PROCESSING OPERATIONS

(76) Inventor: Anthony C. Bonora, Portola, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/766,620

(22) Filed: Jun. 21, 2007

Related U.S. Application Data
(60) Provisional application No. 60/815,890, filed on Jun. 22, 2006.

(51) Int. Cl. B65G 49/00; B65G 47/24

(52) U.S. Cl. 414/749.6; 414/816

(57) ABSTRACT

A substrate support and transport system for substrates to be processed is provided. The substrate support system includes a conveying mechanism for supporting the substrate in a vertical orientation. The conveying mechanism includes a moveable base supporting a bottom edge of the substrate and a non-contact support arm providing support to a side of the substrate. The substrate support system includes a housing disposed over the moveable base and substantially enclosing the substrate and the non-contact support arm. An air supply providing an air supply directed from a top edge of the substrate toward the base is included in the substrate support and transport system. A method of transporting a substrate is also provided.

### CLAIM OF PRIORITY

The present application claims priority under 35 U.S.C. § 119(e) from U.S. Provisional Patent Application No. 60/815,890, filed Jun. 22, 2006, which is incorporated by reference in its entirety for all purposes.

### BACKGROUND

Currently, flat panel displays, such as liquid crystal displays (LCDs), organic light emitting diode displays and the like, are used in a wide variety of display applications. A flat panel display is produced by conveying a glass substrate to processing equipment located at the respective stations of a flat panel display manufacturing line. The flat panel display is processed and then transported to a next processing tool. A conventional flat panel display transferring system may include a cassette, a stocker, a conveyor or other transport means, and an indexer. In the conventional system, the cassette, in which a plurality of substrates is loaded, is stored in the stocker. The stored cassettes may be transported by the stocker to the entrance of processing equipment. The indexer is then used to move the substrates in the cassette into and out of the processing equipment at the respective entrances of the processing stations. As mentioned above, in the current scheme for transferring flat panel displays, the displays are held in the horizontal position throughout the transfer, as this is the manner in which the substrates are processed in the processing tools. As the substrates for the flat panel displays are becoming larger, the footprint for the cassettes is also substantially increasing. In addition, the cassettes used to store the large substrates are expensive.

As a result, there is a need to solve the problems of the prior art to provide a system and method for transporting flat panel display substrates while minimizing the footprint for the system.

### SUMMARY

This invention provides a system for transporting relatively large substrates, such as flat panel displays. It should be appreciated that the present invention can be implemented in numerous ways, including as a method, a system, or an apparatus. Several inventive embodiments of the present invention are described below.

In one embodiment of the invention, a substrate support and transport system for substrates to be processed is provided. It should be appreciated that the embodiments described herein may apply to the transportation, queuing and loading of any large substrate including substrates that support solar cells, or solar panels where the thin film panel is the solar cell. The substrate support system includes a conveying mechanism for supporting the substrate in a vertical orientation or a near vertical orientation. The conveying mechanism includes a moveable base supporting a bottom edge of the substrate and a support arm providing support to a side of the substrate. The moveable base may be a slide, belt, or wheels. In one embodiment, the support arm is a non-contact support arm. However, the support arm may contact the substrate surface, e.g., a belt or rollers may be used to support the substrate in the contact embodiment. The substrate support system may include a housing disposed over the moveable base and substantially enclosing the substrate and the non-contact support arm. An air supply providing a clean environment is included. In one embodiment, the air shower or air supply is directed from a top edge of the substrate toward the base, however, various alternatives may be used for the air supply orientation to still maintain a clean environment.

In another embodiment, a system for transporting a substrate for flat panel displays is provided. The system includes a conveying mechanism for supporting the substrate in a substantially vertical orientation, the conveying mechanism including a moveable base supporting a bottom edge of the substrate and a non-contact support arm providing support to a side of the substrate. The movable base imparts lateral movement of the substrate while a side surface of the substrate is being supported. The system includes an indexing unit operably connected to the conveying mechanism. The indexing unit is configured to store a plurality of substrates in a vertical orientation. A transfer mechanism configured to lift and orient the substrate from the vertical orientation of the conveying mechanism to a horizontal orientation for placement into a processing tool is also included in the system.

In yet another embodiment, a method for manufacturing a substrate for a flat panel display, is provided. The method initiates with placing the substrate in a substantially vertical orientation wherein a bottom edge rests on a transport mechanism. The substrate is then moved along a surface of the transport mechanism. A planar surface extending from the bottom edge of the substrate is supported during the moving. In one embodiment the substrate is supported through an air bearing provided through a support rail. The substrate is transitioned from the vertical position to a horizontal position for introduction into a process tool.

Other aspects and advantages of the invention will become apparent from the following detailed description, taken in conjunction with the accompanying drawings, illustrating by way of example the principles of the invention.

### BRIEF DESCRIPTION OF THE DRAWINGS

Aspects of the present invention will become apparent from the following detailed description, taken in conjunction with the accompanying drawings, illustrating by way of example the principles of the invention.

FIG. 1 is a simplified schematic diagram illustrating the material transport and queuing system in accordance with one embodiment of the invention.

FIG. 2 is a simplified schematic diagram illustrating a cross-sectional view of the controlled environment in accordance with one embodiment of the invention.

FIG. 3 is a simplified schematic diagram showing a cross sectional view of the flat panel display resting on a transport mechanism such as a conveyor assembly in accordance with one embodiment of the invention.

FIG. 4 is a simplified schematic diagram illustrating a lift and rotate device configured to transition a flat panel display from a vertical orientation to a horizontal orientation and vice versa in accordance with one embodiment of the invention.

FIG. 5 is a flow chart diagram illustrating the method operations for manufacturing a substrate for a flat panel display in accordance with one embodiment of the invention.

### DETAILED DESCRIPTION

An invention is described for a system and method for transporting, queuing and loading large are substrates in multi-tool processing operations. It will be obvious, however, to one skilled in the art, that the present invention may be practiced without some or all of these specific details. In other instances, well known process operations have not been described in detail in order not to unnecessarily obscure the present invention.

The embodiments below describe a flat panel display material transport and queuing system. In one embodiment, the flat panel display is held in a vertical orientation and transported through a combination of gravity-based edge supports and backside non-contact supports, which may incorporate air bearings to achieve non-contact support. It should be appreciated that the non-contact supports minimize particulates. The gravity based edge support elements may either be driven, e.g., a belt or conveyor-type configuration, or the edge supports may be idler wheels. In one embodiment, the system includes indexable storage modules to preserve the vertical orientation of the substrates and allow for space efficient queuing of multiple substrates upstream of a process tool. The indexable storage modules are controllable to either enable through-way passage of traveling substrates or loading/storage of the substrates. Working in conjunction with indexers are tool loading robots which serve to extract substrates from the indexers and orient them with the horizontal loading plane common to most process and inspection tools. It should be noted that a tool executing a process compatible with vertical loading may be provided with a substrate in a substantially vertical orientation. That is, the substrates are horizontally oriented where mandated by the tool and in some instances may be provided to the tool in the substantially vertical orientation, thereby eliminating the need for some tool loading robots to orient the substrates horizontally.

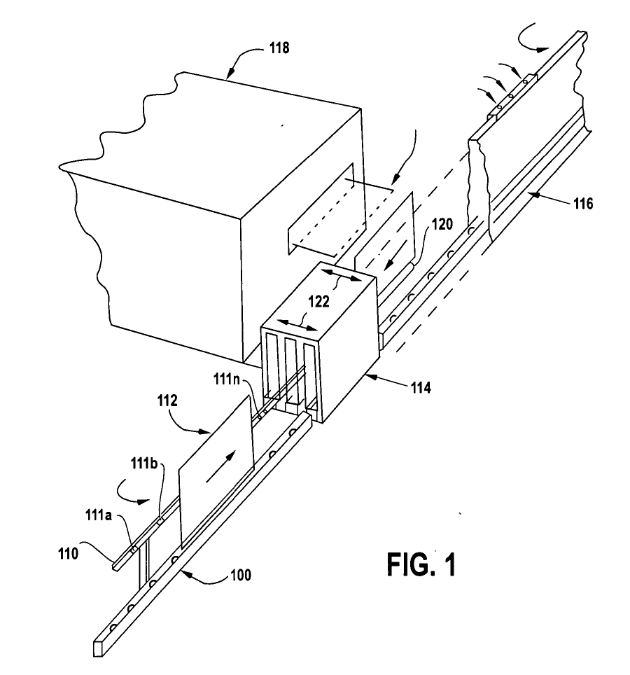

FIG. 1 is a simplified schematic diagram illustrating the material transport and queuing system in accordance with one embodiment of the invention. In FIG. 1, conveyor assembly 100 includes supports for a bottom edge of flat panel display 112, while air bearing support rail 110 provides backside support to flat panel display 112. Of course, a belt or roller may be used in place of air bearing support rail 110 to provide backside support to the substrate. As mentioned previously, the edge support of conveyor assembly 100 may be belt driven, wheel driven or some other suitable conveying mechanism which will impart motion to flat panel display 112. Air bearing support rail 110 will project an air barrier against a side of flat panel display 112 in order to maintain the flat panel display in a substantially vertical position for transportation purposes. The air bearing is generated through the flow of air through apertures 111a-n defined on air bearing support rail 110. Rather than apertures, a porous membrane or surface may be used to provide the air bearing in one embodiment. In yet another embodiment, the air bearing may be provided through a self-adaptive aerodynamic blockage mechanism, available from CoreFlow Scientific Solutions Ltd. of Israel. One skilled in the art will appreciate that the spacing, size, and air flow through apertures 111a-n is any suitable amount that supports the flat panel display. In one embodiment, the vertical orientation (also referred to as the angle of inclination) of flat panel display 112 is between about 1 and 10 degrees from a vertical axis of a top surface of conveyor assembly 100 in order to prevent the flat panel display 112 from tipping during transportation. In another embodiment, the angle of inclination is less than 15 degrees. One skilled in the art will appreciate that the panels are relatively thin, therefore stabilization in the vertical orientation is provided through the embodiments described herein. Thus, in these embodiments air bearing support rail 110 allows flat panel display 112 to lean at up to a 15 degree angle toward the air bearing support rail. Air bearing support rail 110 extends along a length of conveyor assembly 100 and supports the flat panel display at a midpoint, or above the midpoint, of the side opposing the air bearing support rail in one embodiment. In another embodiment, multiple support rails at varying heights above the conveyor assembly may be used for support rather than a single support rail.

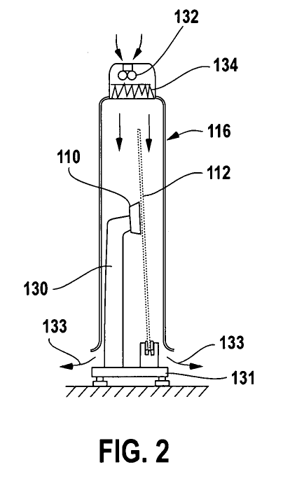

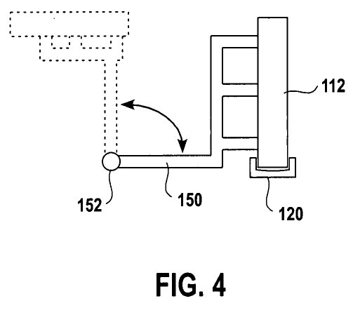

Conveyor assembly 100 feeds flat panel display 112, as the flat panel display is supported through air bearing support rail 100, into indexing unit 114. Indexing unit 114 acts as a queuing device in one embodiment. As illustrated, indexing unit 114 has three slots, 114a-c, each of which are capable of accepting flat panel display 112 therein. It should be appreciated that indexing unit 114 may move in a plane as specified by arrows 122, which is orthogonal to a travel direction of flat panel display 112. Indexing unit 114 may store flat panel displays temporarily during the processing. That is, indexing unit 114 may act as a buffer or stocker for storing the flat panel displays during the manufacturing operation so that process tool 118 is fully utilized. It should be noted that indexing unit 114 may house any number of substrates through the addition of slots to the indexing unit. Indexing unit 114 outputs flat panel display 112 to an optional articulating lift and rotate device that transitions the flat panel display from a vertical position to a horizontal position. Bottom edge support 120 initially accepts the substrate from indexing unit 114 and the lift and rotate device loads process tool 118 with flat panel display 112. In one embodiment, the lift and rotate device will capture a bottom edge of flat panel display 112 and through vacuum suction cups which may be used to support a backside of flat panel display 112, the lift and rotate device will subsequently lift and rotate the flat panel display to a horizontal position in order to prepare the flat panel display for insertion into process tool 118. It should be appreciated that mechanical stops may alternatively be used to support the backside of flat panel display 112 in place of the vacuum suction cups. Process tool 118 may be any suitable device which is utilized in the processing of flat panel displays or other relatively large substrates. Upon completion of the processing sequence within process tool 118, the flat panel display is removed from process tool 118 and returned to conveyor assembly 112 through the lift and rotate device. Further details on the lift and rotate device are provided with reference to FIG. 4. The flat panel display will then proceed on conveyor assembly 100 and may traverse through a controlled environment which could cover a substantial portion of conveyor assembly 100. In one embodiment, the environment provided within housing 116 is a Class 1 environment. Alternatively, the environment may be maintained to meet a class 100 standard. It should be appreciated that the class level may be designated per Federal standard 209E or ISO standards. Housing 116 may extend over any vertical transport region that flat panel display 112 traverses. In addition, the controlled environment may be integrated into indexing unit 114. Further details on housing 116 and the controlled environment therein, are provided with reference to FIG. 2. One skilled in the art will appreciate that the embodiments described herein may be applied to a processing scheme having multiple processing tools and a single processing tool is depicted in FIG. 1 for ease of illustration.

Still referring to FIG. 1, in one embodiment conveyor 100, indexing unit 114, and remaining components of the transport mechanism may be disposed below a floor surface. In this embodiment, the flat panel display would be lifted from the sub floor conveying apparatus and transitioned into process tool 118 through a lift and rotate device. Upon completion of the processing, the flat panel display is returned to below the floor surface to be transported to the next destination in a vertical orientation. Of course, the substrates may also be transported along a conveying mechanism supported on the ceiling. Here, the substrates would be brought down to a process tool and then returned up to the conveying mechanism. One skilled in the art will appreciate that the sub-floor and ceiling embodiments would save floor space when floor space is at a premium.

FIG. 2 is a simplified schematic diagram illustrating a cross-sectional view of the controlled environment in accordance with one embodiment of the invention. The controlled environment is provided within housing 116. Flat panel display 112 is contained within a cavity defined by housing 116. As illustrated, flat panel display 112 is at an angle with respect to a vertical axis of base 131. Air bearing support rail 110 provides the backside support for flat panel display 112 within the controlled environment. It should be appreciated that air bearing support rail 110 in one embodiment does not contact a surface of flat panel display 112. That is, air bearing support rail 110 is a non-contact support. Air bearing support rail 110 is affixed to arm extension 130, which extends from base 131 by a height that is at least as tall as the midpoint of the height of a side of the substrate being supported in one embodiment. Base 131 provides support for edge support elements that may impart lateral movement to a substrate edge resting thereon. Housing 116 includes a top-mounted filtration system that maintains the controlled environment within housing 116. It should be noted that housing 116 is optional and depending on the nature of the substrates being processed may or may not be incorporated with the embodiments described herein. The top mounted filtration system includes fan 132 and filter 134. Filter 134 may be any suitable high efficiency particulate air (HEPA) filter commonly used to provide a Class 1 environment. Fan 132 provides air flow through the filter so that flat panel display 112 will be maintained in an air supply of clean air. In one embodiment, a pressure within the cavity defined within housing 116 is greater than a pressure outside of housing 116 to prevent particulates from entering the cavity. Housing 116 may be affixed to base 131 for support. In another embodiment, this support structure may include a number of perforations, e.g., a screen in between the supports, to enable air flow to escape as indicated by arrows 133, thereby providing the ability to manage the flows of clean air. While the embodiments of FIG. 2 illustrate a top mounted filtration system, this is not meant to be limiting, as the air flow may be provided from a bottom up, side to side, side to bottom, or side to top configuration to provide the clean environment.

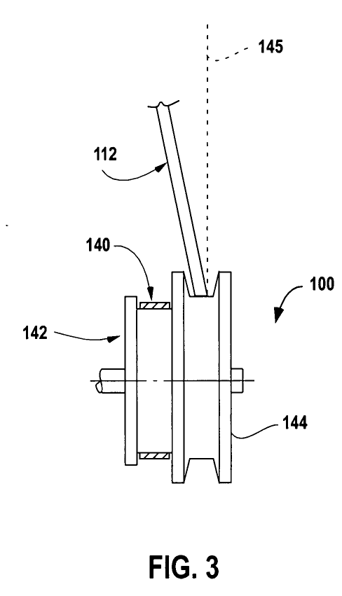

FIG. 3 is a simplified schematic diagram showing a cross sectional view of the flat panel display resting on a transport mechanism such as a conveyor assembly in accordance with one embodiment of the invention. The transport system for conveyor assembly 100 includes a drive belt 140 mounted on a support and drive assembly 142. Drive belt 140 will be used to drive wheel 144 in order to impart motion to flat panel display 112 in the direction of the rotation of wheel 144. Alternatively, drive belt 140 may drive a wheel that drives a belt supporting the flat panel display. Here again, flat panel display 112 is shown leaning towards one side in order to provide support. As mentioned above the angle between axis 145 and a surface of flat panel display 112 is less than 15 degrees in one embodiment. In another embodiment, a complimentary air bearing support rail may be used to guide flat panel display 112 in a substantially vertical orientation. That is, flat panel display 112 may be disposed between opposing air bearing supports which will enable a substantial vertical transportation for the flat panel display. Wheel 144 is configured to accept the edge of flat panel display 112 into a recess defined around the wheel. One skilled in the art will appreciate that numerous other gravity-based configurations are possible, such as a conveyor belt having a recessed surface, a guiding surface, such as a ribbed surface, idler wheels, etc.

FIG. 4 is a simplified schematic diagram illustrating a lift and rotate device configured to transition a flat panel display from a vertical orientation to a horizontal orientation and vice-versa in accordance with one embodiment of the invention. The lift and rotate device includes support arm 150 which is rotatable around pivot point 152. Support arm 150 is configured to support flat panel display 112 and lift the flat panel display from bottom edge support 120. With reference to FIG. 1, indexing unit 114 may deliver flat panel display 112 into bottom edge support 120 for lifting by the lift and rotate device. In one embodiment, extension arm 150 includes means for supporting flat panel display 112, e.g., vacuum suction through each of the fingers contacting a surface of flat panel display 112 in order to support the flat panel display for transitioning to a horizontal orientation. It should be appreciated that other gripping mechanisms are possible and the invention is not limited to vacuum suction. Of course, lift and rotate device may also be used to remove flat panel display 112 from a processing tool and return the flat panel display to the conveying mechanism by returning the flat panel display to bottom edge support 120. In one embodiment, extension arm 150 also includes means for assisting in the delivery of the flat panel display into the process tool. For example, an air inlet similar to the configuration of air bearing support rail may provide an air cushion so that the flat panel display may slide in the input port of the processing tool. The vacuum would be shut down during the delivery into the input port. While an air supply and vacuum source are not illustrated, one skilled in the art would appreciate that the components requiring the use of these facilities are in fluid communication with these sources. It should be noted that numerous structures may be provided to angularly shift the flat panel display as described with reference to FIG. 4.

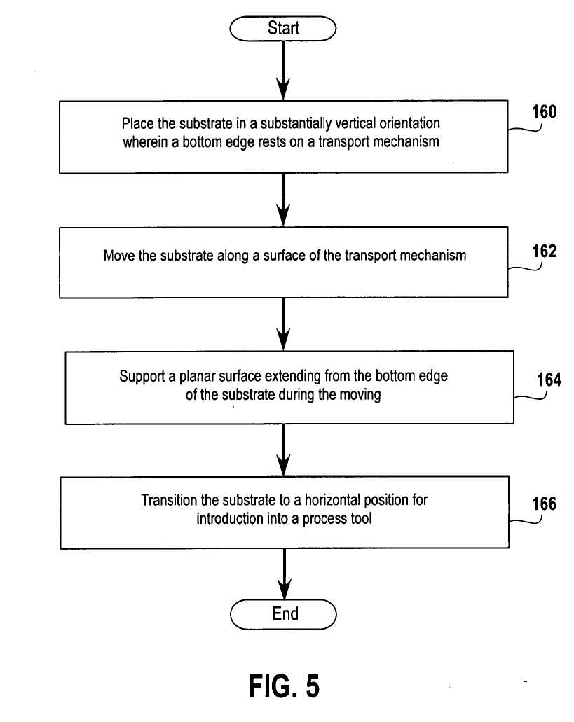

FIG. 5 is a flow chart diagram illustrating the method operations for manufacturing a substrate for a flat panel display in accordance with one embodiment of the invention. The method initiates with operation 160 where the substrate is placed in a substantially vertical orientation wherein a bottom edge rests on a transport mechanism. As described above, a flat panel display is placed into a vertical orientation, such as the gravity based bottom edge supports described with reference to FIG. 1. The method then advances to operation 162 where the substrate is moved along a surface of the transport mechanism. In one embodiment, the substrate motion is imparted through the use of powered wheels or a conveyor belt wherein a bottom edge of the substrate rests in a recess of the wheel or conveyor belt. In another embodiment, the gravity based system is provided where the wheels are idler wheels. The method then advances to operation 164 where a planar surface extending from the bottom edge of the substrate is supported during the moving. Here, a backside surface of the flat panel display or substrate may be supported through the air bearing support rail described above with regard to FIG. 1. In an alternative embodiment, the air bearing support rail or multiple air bearing support rails may exist on both sides of the vertically oriented substrate, in essence creating an air bearing tunnel through which the substrate traverses. Where a single air bearing rail is used to support the planar surface of the substrate, an angle of inclination of about less than 15 degrees will be provided. It should be appreciated that a fluid such as clean air, inert gases, or other compatible fluids may be used to provide an air bearing for the planar surface as the substrate moves along the conveying mechanism. The method then moves to operation 166 where the substrate transitions to a horizontal position for introduction into a process tool. As described with reference to FIG. 4, a lift and rotate device may take the vertically oriented substrate and transition the substrate to a horizontal position so that the substrate may be introduced into a corresponding process tool. It should be noted that once the processing of the substrate is completed through the process tool, the substrate will be taken from the process tool by the lift and rotate device and returned to a vertical orientation from the horizontal position.

In summary, the embodiments described herein provide for the transportation of relatively large substrates such as flat panel displays, which may be used for large flat screen televisions and the like. One skilled in the art would appreciate that these large substrates tend to be thin and relatively flimsy, i.e., lacking in sturdiness. Thus, in a vertical orientation the support provided through the air bearing compensates for this lack of sturdiness so that the substrate can be transported. By orienting the substrate vertically, valuable floor space may be saved as well as cost in eliminating the need for the cassettes currently used in the transport of the flat panel displays. Additionally, it should be noted that the invention is not limited to the actual structures providing the support and lifting mechanisms as these are exemplary structures. That is, any structure accomplishing the functionality described herein may be integrated into the embodiments described above.

One skilled in the art will appreciate that various alternatives to the embodiments described above are available. For example, the mini-environment tunnel 116 may be located within a floor area of a facility and the flat panel displays are lifted to the corresponding process tools. Alternatively, the controlled environment provided by housing 116 may be disposed within a ceiling of a facility and the flat panel displays are lifted off of the conveyor assembly and down to the process tool in this embodiment. By now, those of skill in the art will appreciate that many modifications, substitutions, and variations can be made in and to the materials, apparatus, configurations, and methods of the substrate transferring system of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalence.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims. It should be appreciated that exemplary claims are provided below and these claims are not meant to be limiting for future applications claiming priority from this application. The exemplary claims are meant to be illustrative and not restrictive.

What is claimed is:

1. A substrate support and transport system for substrates to be processed, comprising:
a conveying mechanism for supporting the substrate in a substantially vertical orientation, the conveying mechanism including a moveable base supporting a bottom edge of the substrate and a support arm providing support to a side of the substrate while the substrate moves, and
a housing disposed over the moveable base and substantially enclosing the substrate and the non-contact support arm; and
an air supply providing a clean environment within an area defined by the housing.

2. The system of claim 1, wherein the air supply is affixed to a top portion of the housing and wherein the housing is configured to define an outlet between a bottom of the housing and the moveable base.

3. The system of claim 1, wherein the air supply includes an intake fan and a filter downstream of the intake fan.

4. The system of claim 3, wherein the filter supplies air meeting at least a class 100 standard into the area defined by the housing.

5. The system of claim 1, wherein the support arm is configured as a rail extending along a length of the moveable base of the system.

6. The system of claim 5, wherein the support arm is a non-contact support arm and is configured to support the substrate at an angle less than 10 degrees from a perpendicular axis of a top surface of the moveable base.

7. The system of claim 1, wherein the moveable base is a belt.

8. The system of claim 1, wherein the moveable base is one of a plurality of idler wheels or a plurality of driven wheels.

9. A system for transporting a substrate for flat panel displays, comprising:
a conveying mechanism for supporting the substrate in a substantially vertical orientation, the conveying mechanism including a moveable base supporting a bottom edge of the substrate and a support arm providing support to a side of the substrate, the movable base imparting lateral movement of the substrate;
an indexing unit operably connected to the conveying mechanism, the indexing unit configured to store a plurality of substrates in the substantially vertical orientation; and
a transfer mechanism configured to lift and orient the substrate from the substantially vertical orientation of the conveying mechanism to a horizontal orientation for placement into a processing tool.

10. The system of claim 9, wherein the support arm includes a rail extending along a length of the moveable base and the rail is configured to support the substrate at an angle between about 1 degrees and 10 degrees from a perpendicular axis of a top surface of the moveable base.

11. The system of claim 10, wherein a surface of the rail opposing the substrate includes one of a plurality of apertures or a porous membrane having air flowing therethrough to provide an air bearing.

12. The system of claim 9, wherein the indexing unit includes a plurality of lanes and the indexing unit is orthogonally moveable relative to the lateral movement of the substrate.

13. The system of claim 9, wherein the moveable base is one of a belt having one of a recess or a guiding feature configured to accommodate the bottom edge of the substrate or a plurality of wheels having a grooved perimeter surface to accommodate the bottom edge of the substrate.

14. The system of claim 9, wherein the transfer mechanism is configured to angularly shift the substrate.

15. The system of claim 9, wherein the support pad has a plurality of holes through which vacuum is applied to support the substrate during lifting and orienting.

16. A method for transporting a large area substrate, comprising:
placing the substrate in a substantially vertical orientation wherein a bottom edge rests on a transport mechanism;
moving the substrate along a surface of the transport mechanism;
supporting a planar surface extending from the bottom edge of the substrate during the moving; and
transitioning the substrate to a horizontal position for introduction into a process tool.

17. The method of claim 16, wherein the placing of the substrate in the substantially vertical orientation includes leaning the substrate between about 1 to about 10 degrees from a vertical axis of the transport mechanism.

18. The method of claim 16, wherein the supporting of the planar surface includes flowing a fluid through a rail member opposing the planar surface.

19. The method of claim 16, further comprising:
encasing a transport pathway of the substrate; and
flowing a filtered fluid from a top edge of the substrate to the bottom edge of the substrate as the substrate moves.

20. The method of claim 16, further comprising:
storing multiple substrates within an indexing unit located prior to the process tool.

21. A method for transporting, queuing, and loading a flat panel display, comprising:
placing the flat panel display in a substantially vertical orientation wherein a bottom edge rests on a transport mechanism;
moving the flat panel display along a surface of the transport mechanism;
supporting a planar surface extending from the bottom edge of the flat panel display during the moving; and
transitioning the flat panel display to a horizontal position for introduction into a process tool.

22. The method of claim 21, wherein the placing of the flat panel display in the substantially vertical orientation includes leaning the flat panel display between about 1 to about 10 degrees from a vertical axis of the transport mechanism.

23. The method of claim 21, wherein the supporting of the planar surface includes flowing a fluid through a rail member opposing the planar surface.

24. The method of claim 21, further comprising:
encasing a transport pathway of the flat panel display; and
flowing a filtered fluid from a top edge of the flat panel display to the bottom edge of the flat panel display as the flat panel display moves.

25. The method of claim 21, further comprising:
storing multiple flat panel displays within an indexing unit located prior to the process tool.
